(19) United States
(12) Patent Application Publication
(10) Pub. No.: US 2014/0012666 A1
(43) Pub. Date: Jan. 9, 2014

(54) TRANSFERRING DIGITAL MEDIA RIGHTS IN SOCIAL NETWORK ENVIRONMENT

(71) Applicant: OpenTv, Inc., San Francisco, CA (US)

(72) Inventors: Frantz Lohier, El Cerrito, CA (US); Pierre Sarda, Echallens (CH)

(21) Appl. No.: 13/924,394

(22) Filed: Jun. 21, 2013

Related U.S. Application Data
(60) Provisional application No. 61/668,611, filed on Jul. 6, 2012.

(51) Int. Cl. G06Q 20/12; G06Q 50/00

(52) U.S. Cl. CPC G06Q 20/1235; G06Q 50/01
USPC 705/14.49

(57) ABSTRACT

In various example embodiments, systems and methods for transferring digital media rights in a social network environment are provided. For example, an indication to transfer digital rights in a digital content is received from a user of a social network. A first network connection in the social network associated with the user is determined. An advertisement of the digital content and an offer to transfer the digital rights may be presented to the first network connection. The digital rights in the digital content may be transferred to the first network connection.

### RELATED APPLICATION

The present application claims the priority of U.S. Provisional Patent Application Ser. No. 61/668,611, filed Jul. 6, 2012 and entitled “Transferring Digital Media Rights in Social Network Environment,” which is hereby incorporated by reference.

### FIELD

The present disclosure relates generally to digital content resale, and in a specific example embodiment, to transferring digital media rights in a social network environment.

### BACKGROUND

Conventionally, the sale of digital rights is complex. Unlike the physical transfer of media such as a CD or DVD, once a user owns digital rights to a digital content, the resale or transfer of the content, or more generally, monetization becomes difficult especially if rights of content owners are to be appropriately respected.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for transferring digital media rights may be implemented.

FIG. 2 is a block diagram illustrating an example embodiment of a content management system.

FIG. 3 is a flow diagram of an example method for transferring digital media rights in a social network.

FIG. 4 is a flow diagram of an example method for advertising to network connections.

FIG. 5 is a flow diagram of an example method for managing multiple transfers of a particular digital media content.

FIG. 6 is an example screenshot of a seller's social network page.

FIG. 7 is an example screenshot of a social network page of a user who has been gifted digital content.

FIG. 8 is a simplified block diagram of a machine in an example form of a computing system having a set of instructions perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for transferring digital media rights in a social network environment. In example embodiments, an indication to transfer digital rights in a digital content is received from a user of a social network. A first network connection in the social network associated with the user is determined. The first network connection may be determined by accessing profiles of the user and profiles of a plurality of network connections of the user and determining commonalities (e.g., similarity of predefined parameters in the profiles of the user and the first network connection. Alternatively, the first network connection may be determined by determining a characteristic of the digital content, accessing profiles of a plurality of network connections of the user, and determining that the profile of the first network connection indicates a preference for the characteristic of the digital content. An advertisement of the digital content (or a link to the advertisement) and an offer to transfer the digital rights in the digital content may be presented to the first network connection. The digital rights in the digital content may be transferred to the first network connection. The transfer may be a gift or a purchase transaction.

If a second network connection desires to purchase the digital content, a determination is made as to whether the user has further digital rights in the digital content to be transferred. Based on the user having the further digital rights, the digital rights may be transferred to the second network connection. However, if the user does not have the further digital rights, a determination is made as to whether other users in the social network are selling the digital rights to the digital content. Based on at least one other user in the social network selling their digital rights, an oldest inventory of the digital content and thus the corresponding digital rights may be transferred to the second network connection. However, if no other users in the social network are selling their digital rights, a notification indicating a third party retailer selling the digital content may be provided.

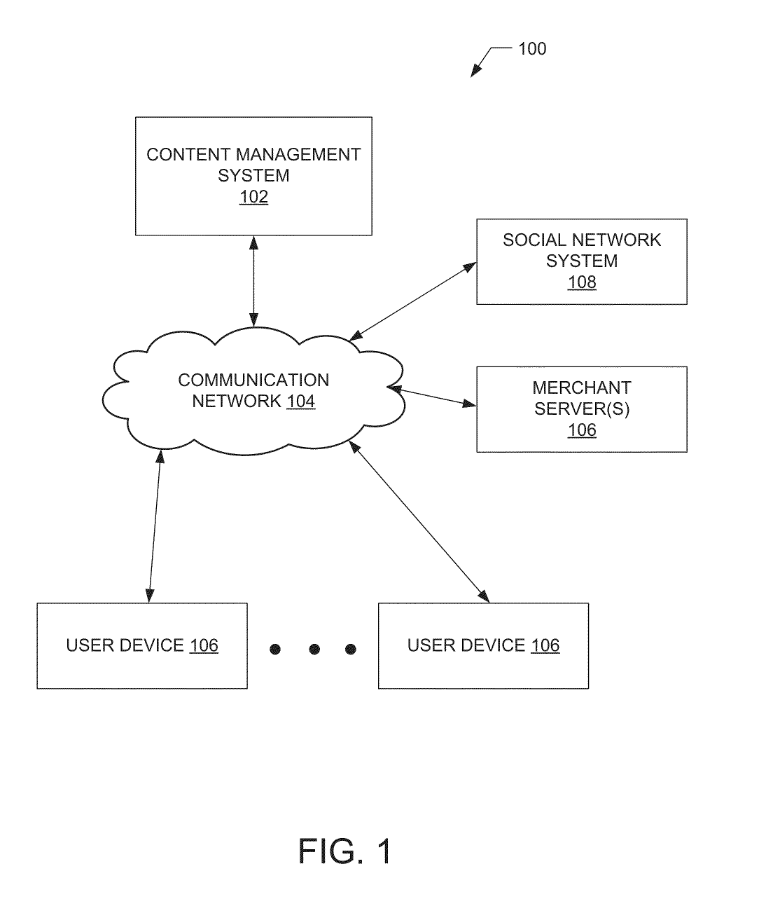

With reference to FIG. 1, a diagram illustrating an example environment 100 in which embodiments of a system for transferring digital media rights in a social network is shown. The environment 100 comprises a content management system 102 coupled via a communication network 104 (e.g., the Internet, wireless network, cellular network, or a Wide Area Network (WAN)) to a plurality of user devices 106. Each user device 106 is associated with a user that accesses a social network via the communication network 104. The user device 106 may comprise a mobile phone, laptop, tablet, or any other communication device that a user may utilize to access the communication network 104.

The social network is provisioned by a social network system 108 that may include one or more servers. The social network may include, but is not limited to, Facebook, Twitter, Google+, MySpace, Bebo, and Habbo. Thus, a social network is any virtual or electronic, telecommunication-enabled collection of individuals forming a community for sharing information. Example embodiments use an existing social network as the platform to conduct interactions between sellers and potential buyers. The term “seller” may refer to any variety of transferors, which the term “buyer” may refer to any variety of transferees. The social network may also include a sub-circle of connections based on resell interactions. For purposes of discussion, social network and social network environment may be used interchangeably. In some cases, the social network environment may include more than one social network.

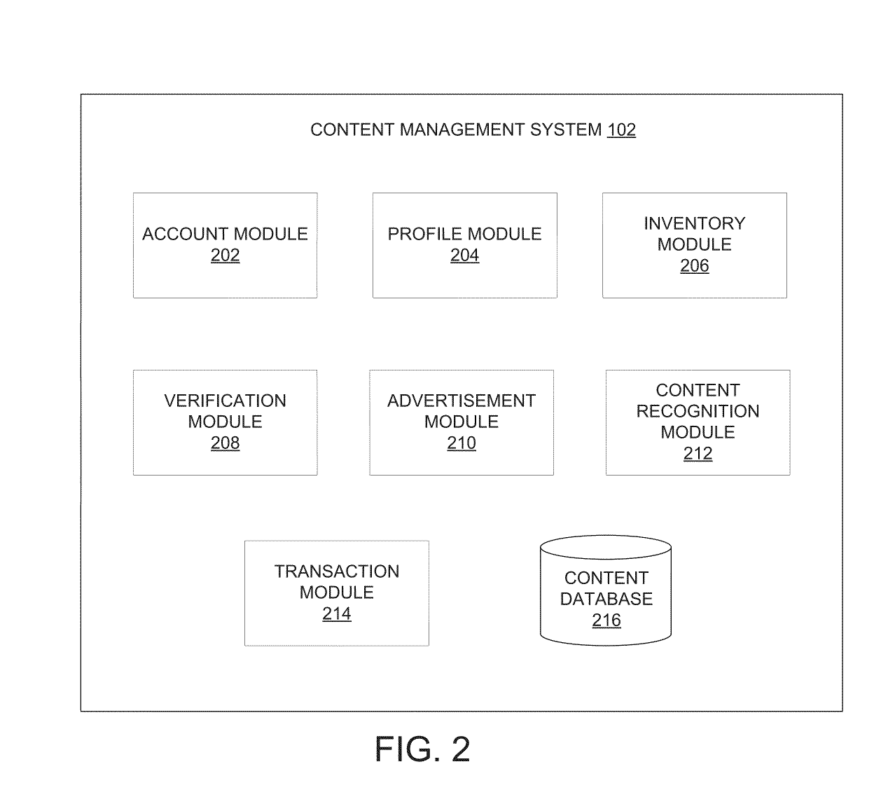

The content management system 102 comprises a central server (or a plurality of servers) that manages the transfer of digital media rights in the social network environment. In example embodiments, the content management system 102 communicates with the social network server 108 to share data that enables the offer and transfer of digital media rights between members of the social network. It is noted that the content management system 102 may manage more than one social network and thus be coupled to more than one social network systems 102. The content management system 102 will be discussed in more detail in connection with FIG. 2 below.

In example embodiments, the social network system 108 provides graphical user interfaces that allow the members of the social network to share information with other members. The other members may be indicated as “friends” of the member and be granted certain privileges or access to information that general members who are not known or “friended” by the member cannot access. Accordingly, example embodiments allow the user (i.e., member) to offer a digital media right for transfer to friends and other members of the social network. In some cases, the offer or an advertisement presenting the offer may be displayed on the member's social network page (e.g., homepage). Thus, digital content may be offered via a layout of a user interface that the users are already familiar with. Persons skilled in the art will recognize how targeted advertisement servers in a social network environment provide a technical example of how to implement some facets of example embodiments.

In example embodiments, digital media rights are transferred between members of the social network. However there may be occasions when digital media rights become unavailable within the social network. In these cases, the content management system 102 may look outside of the social network for available digital content or media. As such, one or more merchant servers 106 of retailers may be coupled to the communication network 104 to enable purchase of the digital content from third party retailers or other seller aggregators. Further discussion of the interactions with retailers will be discussed in more detail below.

It is noted that the environment 100 shown in FIG. 1 is exemplary. For example alternative embodiments may comprise any number of content management systems 102, user devices 106, and social network systems 108 in the environment 100. In some embodiments, the content management system 102 (or parts of the content management system 102) may be a part of the social network system 108 and the functions of the content management system 102 will be incorporated into the social network system 108.

Referring now to FIG. 2, a block diagram illustrating an example embodiment of the content management system 102 is shown. The contact management system 102 acts as a transform platform and coordinates the transfer of the digital rights with its associated content from one user to another within the social network. To enable these operations, the content management system 102 comprises an account module 202, a profile module 204, an inventory module 206, a verification module 208, an advertisement module 210, a content recognition module 212, a transaction module 214, and a content database 216 coupled in communication. The content management system 102 exchanges data and instructions with the social network system 108 in order to enable use of the user interfaces (e.g., social network pages) of the social network for transacting digital content transfers.

The account module 202 manages an account for the user with the content management system 102. In some embodiments, user information from the social network is linked to the content management system 102 and associated with the account on the content management system 102. In these embodiments, a user logging into their social network will also activate the user's account at the content management system 102 that manages digital rights transfers. As a result, for example, a buyer may purchase digital media content (e.g., the rights to view digital content) without having to leave the social network environment.

In alternative embodiments, the users may not have accounts at the content management system 102. Instead, the social network account at the social network system 108 (or that portion or instance accessible by applications outside the social network) may be accessed by the account module 202 and information needed to conduct a digital rights transfer may be obtained from the social network account. A federated account may also be used.

The profile module 204 manages preferences associated with the users. These preferences may be used by the content management system 102 to target other users (e.g., members of the social network) to which to offer digital content (e.g., forward a notification). In example embodiments, the social network system 108 creates or maintains personalized profiles for each user based on the information and data entered by each individual user. This data includes, but is not limited to, likes, interests, dislikes, hobbies, and preferences of each user, which can be discovered through automatic semantic analysis performed on, for example, user's posts. The profile module 204 may access this data and based on this data, the seller may automatically advertise (via the advertisement module 210) the sellers inventory to friends who may be interested in content available for resale by the seller. For example, a seller may have a movie in which ActorX is an actor (e.g., characteristic of the movie). The seller may also have several friends who have listed ActorX as their favorite actor. When the seller uploads content for resale that has ActorX tagged as an actor, an automatic message or notification may be sent to all of the seller's friends who have indicated ActorX as an interest by the advertisement module 210. This notification indicates that the digital content with ActorX is available for purchase in the resale market. By uploading digital content with certain tags, the advertisement module 210 may automatically generate a recommendation to interested social network connections based in part on the seller's profile and/or the profiles of friends of the seller. As a result, the seller does not have to manually make recommendations to individual friends in the seller's social network. In further embodiments, profiles of every user within a particular social network (e.g., Facebook) may be analyzed and targeted advertisement may be sent. Therefore, the buyer and seller may be in the same network but are not necessarily directly connected, or they may be in different networks.

The inventory module 206 manages the inventory of digital content and the corresponding digital rights available for sale or transfer across various social network platforms. Initially, the inventory module 206 receives an indication from a user that the user wants to sell a particular piece of digital content. The inventory module 206 may trigger the verification module 208 to verify whether the seller has an ability to legally sell or transfer their digital content. In example embodiments, the verification module 206 may determine the rights encompassed by a digital certificate (e.g., license) associated with the digital content. The verification module 206 may also determine parameters of the transferred rights. For example, if a digital certificate or license grants rights for viewing a digital content five times and the seller has viewed it twice, then the rights available for transfer is limited to three view rights.

Once the verification module 206 verifies the validity of the digital certificate, the digital certificate for resale may be placed into the content database 216 by the inventory module 206. Additionally, the seller's access to the digital content may be blocked for the duration of time the content is placed for resale by the inventory module 206.

In example embodiments, the instances of identical digital content with identical prices may be placed in a stack that is ordered first-in-first-out in the content database 216. This allows the oldest inventory to be sold first in embodiments where a member's copy is already sold to a friend as will be discussed in more detail below. In some embodiments, the price may be decreased if the first-in-first-out does not empty quickly enough or if no one is interested in the resale of the product at the current price. In other embodiments, the digital goods stack may be ordered using other criteria (e.g., closeness in the social graph to the user or intended buyer/offeree of the rights).

The inventory module 206 also manages lists of retailers (e.g., associated with the merchant servers 106). For example, when a seller places movie M for resale, the movie M from the seller is added to an inventory list for the particular digital content (i.e., movie M) by the inventory module 206. The inventory list may be a list of inventory available within the social network or be a list of inventory available across all social networks associated with the content management system 102. If the inventory list for the particular digital content does not exist (e.g., this is the first offer of the particular digital content), a new list is created by the inventory module 206. Additionally, the inventory module 206 may search major online retailers of digital media to monitor if identical content is also listed for sale. Metadata or metatags associated with the particular digital content placed for resale indicate specific information about the digital content. The metadata may be used to search the inventory of the online retailers. The inventory module 206 may refresh the search every time an action is taken with respect to each item of digital content. These actions may include, but are not limited to, listing requests (e.g., to list the digital content for sale), purchase requests, and list requests. Digital content that is more popular with buyers and sellers may trigger a more frequent search by the inventory module 206. When the stack of inventory for the particular digital content (e.g., movie M) is empty (e.g., no digital content available in the social network), data regarding the online retailers (e.g., third party vendors) where the digital content is available for purchase may be provided from the list of retailers.

The advertisement module 210 manages the advertising of an offer of the digital content for sale by a seller. In some instances, the seller may choose to use an official trailer for the digital content. As such, the advertisement module 210 provides either a link to the trailer or provides the trailer itself to be displayed on the seller's personalized social network page (hereinafter referred to as “the social network page of the seller”).

In other embodiments, the seller may choose to create their own advertisement using portions of the digital content the seller is selling. For instance, the seller may select a screen image of a scene in a movie or an excerpt of a soundtrack, or the like, and the advertisement module 210 will format and provide the selected portion to the social network system 108 for incorporation into the social network page of the seller. Furthermore, in other embodiments, the seller may choose to use the trailer and add personalized information to the trailer.

By displaying the trailer or portion of content from the digital media on the social network page of the seller, network connections of the seller (e.g., friends) may automatically see what content the seller has placed on the resale market when accessing the social network page of the seller. If the network connection (e.g., potential buyer) decides to view the trailer, for example, the network connection may be linked to the official trailer for the content as produced by the studio or producer. The official trailer may be stored at the content database 216 or at a server associated with the studio or producer. Depending on the social network environment, the official trailer may be played directly on the seller's social network page, the potential buyer may be linked to another page which plays the trailer, or the potential buyer is directly linked to the content.

Besides viewing the trailer or the portion of content, the network connection may choose to sell their own digital rights to the same digital content. In these cases, the network connection uploads their own digital certificate to the content management system 102. It is noted that the network connection's interactions with the content management system 102 is invisible in that the network connection does not have to separately log into any other platform (e.g., the contact management system 102) aside from the social network. That is, the network connection is recognized by the account module 202 of the content management system 102 when the network connection either logs into their account on the social network or interacts with the advertisement on the buyer's social network page.

The content recognition module 212 manages recognition of excerpts of content (e.g., in an advertisement) with associated digital content. In example embodiments, the recognition process is based on intrinsic characteristics of the digital content. The original digital content may be analyzed as a reference and any content excerpts may be compared against the reference.

For example, when the seller uses excerpts of the digital content instead of the official trailer for the digital content to advertise, these excerpts may not be pre-tagged with metadata that links the excerpts automatically with the associated digital content. The content recognition module 212 performs recognition on the excerpts and synchronizes them with the associated digital content. In some cases, once the excerpt is synchronized with a known digital content, the content recognition module 212 may ask (e.g., through a user interface of the social network system 108) for the seller to verify that the recognized digital content is correct. Once verified and recognized, the inventory module 206 may update the inventory list.

In a further embodiment, if the seller alters portions of the digital content (e.g., a trailer) prior to resale, the content recognition module 212 performs a recognition process to identify the portion of the digital content for which the seller wishes to transfer the digital rights to another user in the social network environment. For example, a seller may add a personalized voice or video clip at the beginning of the trailer saying “Hi B. I just watched this movie and thought you might like it.” Once the trailer is altered from its original form, it needs to be resynchronized with the proper identifiers. The content recognition module 212 may take a few frames from the trailer and fingerprint them to recognize the associated digital media content. Once the digital content is recognized, the seller's video clip (e.g., trailer with personalized content) may be posted to the seller's social network page with the appropriate tags.

In further embodiments, the content recognition module 212 may provide recommendations to a viewer based on content the viewer has just finished watching or accessing. Once a viewer (e.g., buyer or seller) has completed watching or accessing a digital content, the content recognition module 212 provides the viewer a list of other similar content available for resale in the social network. If the content accessed by the viewer has pre-defined tags depicting a nature (e.g., genre) of the content such as drama or romance, for example, those pre-defined tags are used to search the inventory by the inventory module 206 for similar tags. However, if the content accessed by the viewer is not pre-defined then the content recognition module 212 is used to determine the nature of the content. Based on these results, the inventory module 206 searches the inventory list for similar content. Identified digital content that contains the most number of similar tags may be recommended to the viewer for purchase.

In a further embodiment, the content recognition module 212 monitors content being viewed by a user in order to provide recommendations of available inventory. For example, if user A is watching a football game or some other live event on user A's device, the content is monitored to see if a reference to any related content which may be available for resale in the content database 216 is made. For instance, if there is a commercial during the football game stating that movie M will be playing on a particular channel in a couple days, the inventory module 206 may be triggered to search the inventory list to determine whether there are any movie M digital rights available for resale. If there is a movie M available for resale, a notification is sent to the viewer indicating that the viewer may already purchase movie M in the resale market. The purchase may be made either directly from the viewer's social connections or from another seller in the social network environment. The viewer's friends may also purchase movie M based on a notification sent to the viewer's connections indicating that the viewer just made a purchase of movie M.

The transaction module 214 manages any transaction involving the transfer of digital rights. In embodiments where the potential buyer triggers a purchase of the seller's digital rights (e.g., selects a “purchase” button on the seller's social network page), the transaction module 214 performs a transfer process. The transfer process may handle exchange of payment and transfer of the digital certificate or digital rights at the content database 216 or at a digital rights datastore or locker (not shown). The transfer occurs in the background and the buyer may simply receive a confirmation that the purchase is completed. Unless the seller has multiple digital certificates or digital rights to the particular digital content, the first network connection to purchase the digital content receives the digital rights directly from the seller. If further digital rights are available, other network connections of the seller may continue to purchase the digital content on the seller's social network page from the seller.

In embodiments where there are more buyers than digital rights from the seller, the transaction module 214 may trigger the inventory module 206 to access the inventory list in the content database 216 and identify the oldest available inventory in the social network environment to be sold first. Other options, such as proximity in the social graph or geographically or the like, may also be used. For example, the oldest inventory of the identical content may be placed for resale by any user of instant social network or any social network managed by the content management system 102. As a result, the buyer and seller may not be users of the same social network (e.g., buyer may be a Facebook user and seller may be a Google+ user). Thus, the sale may connect the buyer to a member of the social network environment that is outside the buyer's direct network (e.g., directly connected to the buyer), and in some cases outside of the buyer's social network (e.g., outside Facebook or Google+). This allows interactions between users who become connected through the digital resale market and share a common interest regardless of network connections. Essentially, the content management system 102 brings two individuals together to create a digital rights transaction using the social network environment.

As an example, a seller wants to sell movie M. A buyer is friends with seller in the social network and is thus immediately informed of the opportunity to buy this digital right and is able to be the first purchase. The transaction module 214 transfers the rights of the digital certificate of movie M from seller to buyer. Subsequently, a second friend of seller also decides to purchase from the seller's social network page. Instead of indicating that the content is no longer available because movie M has been sold, the transaction module 214 triggers the inventory module 206 to determine if there are other movie M's available for resale in the inventory list (e.g., the inventory of the social network environment). If there are available digital certificates for resale, the rights of the oldest listed inventory are transferred to the seller's second friend.

While example embodiments are discussed using a sales method, it is noted that the seller may choose to auction the digital rights. In these cases, friends place bids on the digital content. In some cases, a maximum price for the digital content may not exceed the original retail value of the digital content.

In embodiments where the inventory list does not include any further digital rights available for the digital content, a buyer may be linked to third party vendor or retailer (e.g., the merchant server 106) where digital content is sold. Thus, if the second friend attempts to purchase the digital content and the inventory module 206 determines that no further identical digital certificates are in the inventory list, the transaction module 214 may send a notification to the social network system 108 indicating the inventory is empty for the requested digital certificate. Upon receiving the content management system's notification, the social network system 108 sends a notification (or forwards the notification from the transaction module 214) to the buyer that the content is no longer available for resale. The notification may include direct links to the third party vendors (e.g., eBay and Amazon) that were determined by the inventory module 206 as having the digital content available for purchase. Thus, the inventory module 206 maintains the matching inventory list of major online retail vendors that sell matching content.

In one embodiment, a group of friends may together chose to purchase a digital certificate for a particular digital content. For example, a circle of three friends may purchase the rights to a movie. The cost of the digital certificate may be split evenly amongst the friends. Once one friend is finished watching the digital content, the digital content automatically transfers to the next friend, and so on until all the friends in the group have seen the digital content. The transaction module 214 may transfer the digital certificate to the friend with the highest level of interest in the digital content first. The level of interest may be determined by the friends' social network profiles by the profile module 204. The transaction is dependent on the number of friends and the number of copies allowed by the digital certificate. A group of three friends, for example, may receive the rights to a digital certificate in which there may be three separate purchases (e.g., digital rights for viewing) remaining.

While the content management system 102 is discussed and shown as being separate from the social network system 108, alternative embodiments may combine some or all of the operations and modules of the content management system 102 into the social network system 108. In yet other embodiments, the social network system 108 manages connections between users and the content management system 102 manages links from the users to the digital rights.

While embodiments have been discussed with respect to selling the digital content, alternatively, the digital content may be given as a present or “gifted.” The seller may choose to gift the content to a friend in several manners. In a first embodiment, the seller may select the digital content from their inventory, select a “gift” button on their social network page, and indicate a name of a friend in their social network. This action will transfer the seller's digital to the friend's account. The verification module 208 ensures that the seller has the proper right to sell or transfer his rights to the friend. Once the gift transfer is made to the friend, the seller's rights to the digital content are blocked. In a second embodiment, an image of the digital content may be drag and drop on the social network page over a name icon of the friend. This feature is available on social networks environments with more interactive user interfaces. A third embodiment may use voice recognition technology. A microphone on the user device 106 picks up the seller's voice commands to transfer the digital content to a friend. For example a seller may transfer the seller's ownership of the digital certificate to the friend by saying “gift movie M to Friend B.” The voice recognition makes a match between the keywords in the statement and the digital content in the content database 216. The transaction module 214 then transfers the digital content to the account of the friend and provides the seller with a confirmation. To avoid gift-chain piracy, the gift may only be performed once from the original owner to the first friend or the number of gift transfers may be limited in time (e.g., one gift per month).

While the content database 216 is shown as a part of the content management system 102, alternative embodiments may locate the content database 216 outside but coupled to the content management system 102. Additionally, more than one content database 210 may be utilized.

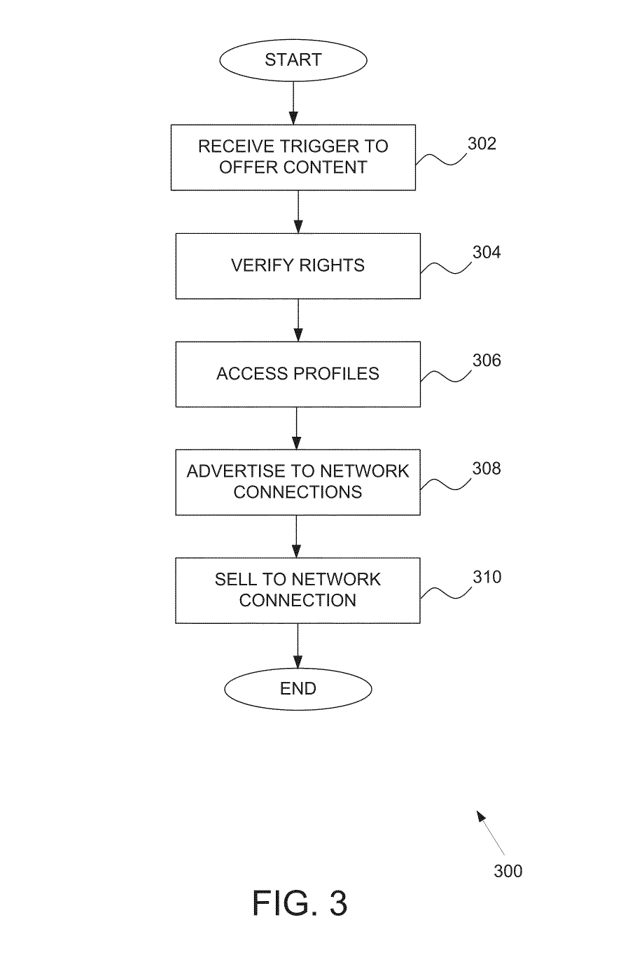

FIG. 3 is a flow diagram of an example method 300 for transferring digital media rights in a social network environment. In operation 302, a trigger is received to offer content. In example embodiments, a seller in a social network may offer (e.g., select a “sell” button on their social network page) a particular digital content for sale. Essentially, the seller is offering his digital rights in the digital content for sale. The inventory module 205 may receive this trigger.

In operation 304, the digital rights in the digital content being offered for sale are verified. In example embodiments, the verification module 206 may verify whether the seller has an ability to legally sell or transfer their digital content. The verification module 206 may also determine the rights and parameters encompassed by a digital certificate associated with the digital content. For example, if a digital certificate or license grants rights for viewing a digital content five times and the seller has viewed it twice, then the rights available for transfer is limited to three view rights.

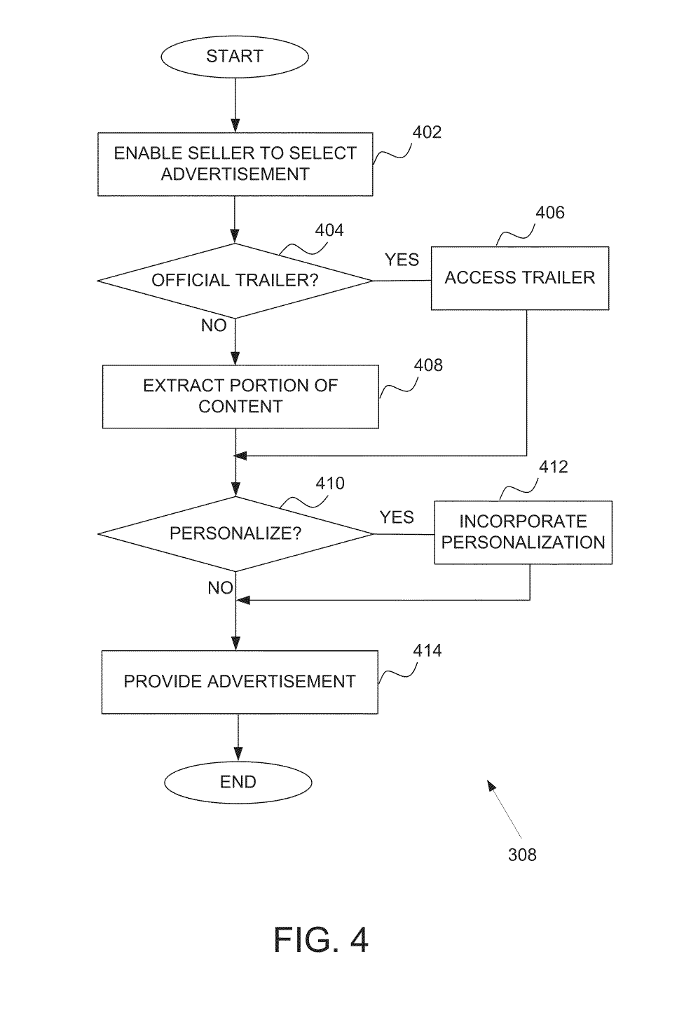

In operation 306, one or more member profiles may be accessed. In example embodiments, the profile module 204 may access the social network profiles of the seller and social connections (e.g., friends) of the seller. By access this data including, for example, likes, interests, dislikes, hobbies, and tastes of these users, the profile module 204 may determine to whom the seller should advertise (via the advertisement module 210) the seller's inventory. Thus, friends who may be interested in content available for resale by the seller may be targeted with a notification in operation 308. Additionally, the advertisement module 210 may instruct the social network system 108 to place an advertisement on the seller's social network page. As a result, any network connections of the seller that visits the seller's social network page would be able to view the advertisement. Operation 308 will be discussed in more detail in connection with FIG. 4 below.

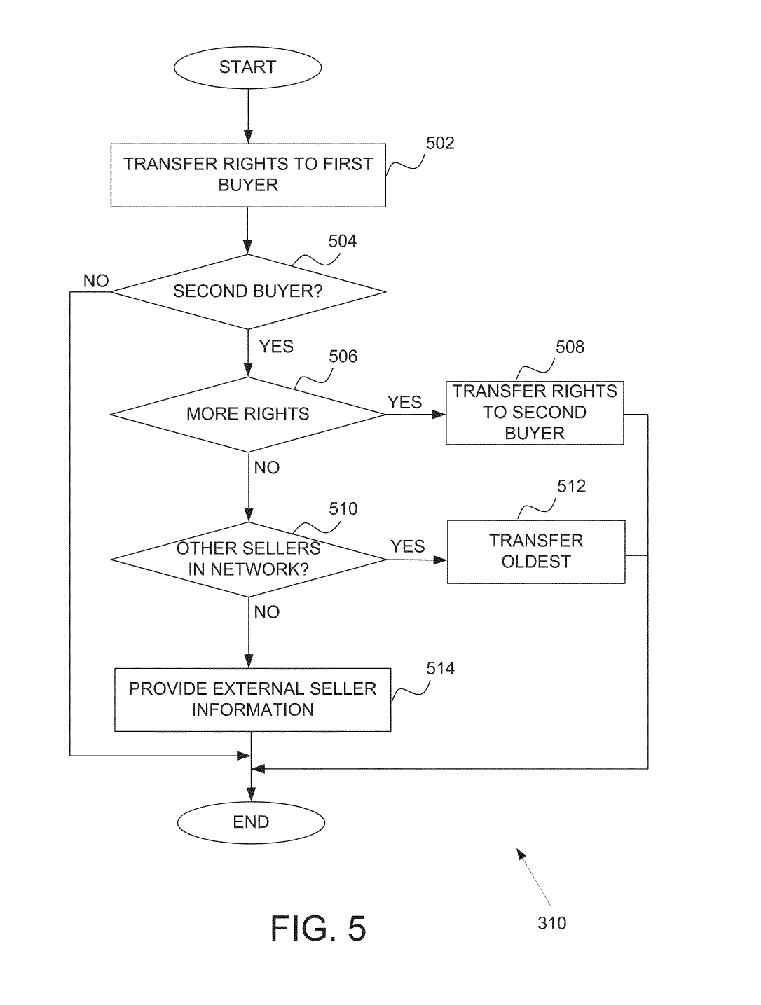

In operation 310, the digital rights are sold, or otherwise transferred, to a network connection. In example embodiments, the transaction module 214 manages the transfer of digital rights. For example, the potential buyer triggers a purchase of the seller's digital rights (e.g., selects a “purchase” button on the seller's social network page). The transaction module 214 may handle exchange of payment. The transaction module 214 also transfers the digital certificate or digital rights at the content database 216 or at a digital rights server (or datastore) to the buyer. The transfer occurs in the background and the buyer may simply receive a confirmation that the purchase is completed. More than one digital right may be transacted in operation 310 as will be discussed in more detail in connection with FIG. 5.

FIG. 4 is a flow diagram of an example a method (operation 308) for advertising to network connections. The operations of the method (operation 308) may be performed by the advertisement module 210 in communication with the social network system 108. The seller may be allowed to select from a plurality of different manners to advertise to network connections. Thus, the seller is enabled to select an advertisement in operation 402. For example, the advertisement module 210 may instruct the social network system 108 to provide advertising options on the social network page of the seller from which the seller may select.

A determination is made in operation 404 as to whether the seller selects to use an official trailer for advertising the digital content. If the seller does select to use the official trailer, then the trailer is accessed in operation 406. In some embodiments, a link may be determined for access to the official trailer at a third party site.

However, if the seller selects not to use the official trailer, then the seller may extract a portion of the digital content (e.g., excerpt) with which to generate an advertisement in operation 408. For instance, the seller may select a screen image of a scene in a movie or an excerpt of a soundtrack, and the advertisement module 210 will format and provide the selected portion to the social network system 108 for incorporation into the social network page of the seller.

A determination is made in operation 410 as to whether the seller wants to personalize the advertisement. If the seller decides to personalize the advertisement, the personalization is incorporated in operation 412. For example, a seller may add a personalized voice or video clip at the beginning of the official trailer saying “Hi B. I just watched this movie and thought you might like it.”

In operation 414, the advertisement is provided. In some embodiments, friends who may be interested in particular digital content available for resale by the seller may be targeted with a notification that includes the advertisement. In other embodiments, the notification may provide a link to the advertisement or a link to the seller's social network page where the advertisement may be viewed. Additionally, the advertisement module 210 may instruct the social network system 108 to place the advertisement on the seller's social network page. As a result, any network connections of the seller that visits the seller's social network page would be able to view the advertisement.

FIG. 5 is a flow diagram of an example method (operation 310) for managing multiple transfers of a particular digital content and corresponding digital rights. In operation 502, the digital rights for the digital content may be transferred from the seller to a first buyer. For example, the first buyer may be friend of the seller who viewed the trailer on the seller's social network page and selects a “purchase” button.

If a second buyer also indicates their intent to purchase the digital content in operation 504, a determination is made in operation 506 as to whether the seller has more digital rights to sell. For example, the seller may have digital rights to view a digital content five times. If the seller has viewed it twice and sold one view right to the first buyer, then there are still two view rights remaining. If the seller does have more digital rights, then the digital rights are transferred to the second buyer in operation 508.

If the seller does not have any further digital rights to sell, then in operation 510, a determination is made as to whether other sellers in the social network are offering the same digital content for sale. In example embodiments, the transaction module 214 may trigger the inventory module 206 to determine if there are other identical digital content (and corresponding digital rights) available for resale in the inventory list (e.g., the inventory of the social network environment). If there are available digital certificates or rights for resale, the rights of the oldest listed inventory are transferred to the second buyer in operation 512.

However, if there are no further identical digital content or rights available for sale in the social network environment, then external seller information may be provided to the second buyer in operation 514. Thus, if the second buyer attempts to purchase the digital rights and the inventory module 206 determines that no further identical digital certificates are in the inventory list, the transaction module 214 may send a notification to the social network system 108 indicating the inventory is empty for the requested digital certificate. Upon receiving the content management system's signal, the social network system 108 sends a notification (or forwards the notification from the transaction module 214) to the buyer that the content is no longer available for resale. The notification may include direct links to the third party vendors (e.g., eBay and Amazon) that were determined by the inventory module 206 as having the digital content available for purchase. The matching inventory list of major online retail vendors that sell matching content is maintained by the inventory module 206.

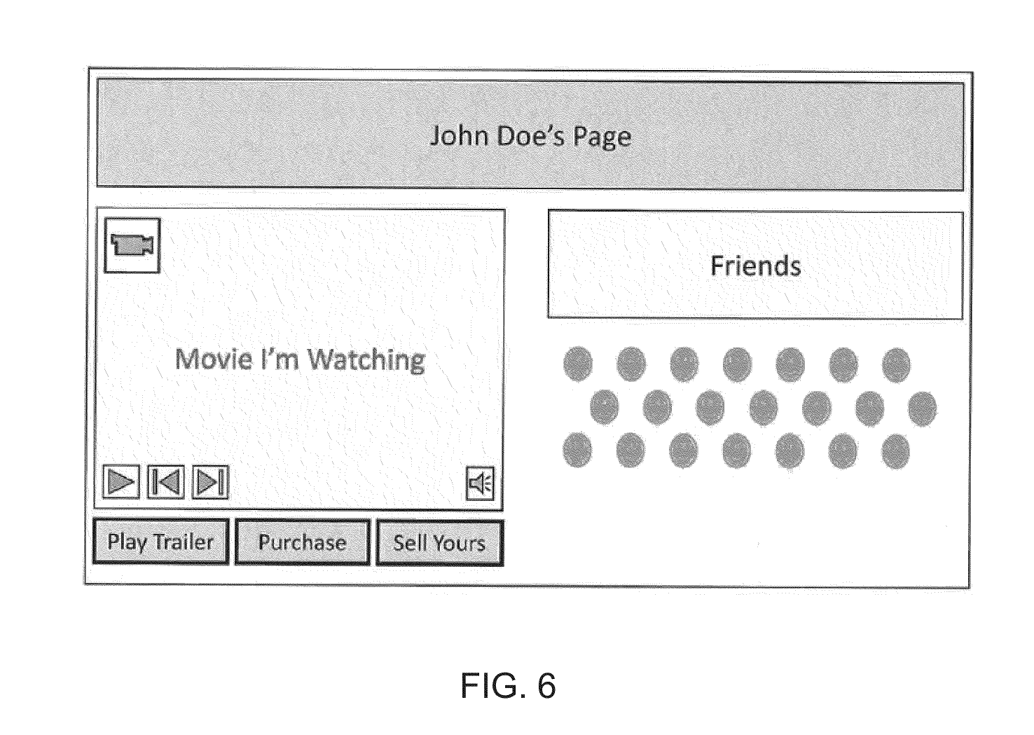

FIG. 6 is an example screenshot of a social network page. In this example screenshot, the user (John Doe) is watching the digital content. Thus, a friend of John Doe may purchase the digital content even before John Doe is finished watching the digital content. For example, John Doe may be watching the digital content which is displayed on John Doe's social network page. John Doe's network connections are able to see the digital content (or a portion of the digital content) that John Doe is watching. The network connections may choose to watch a trailer of the digital content or purchase the digital content (by selecting the respective button) even before John Doe has uploaded the digital certificate for resale. In this case, if a friend selects “purchase,” the transaction module 214 may search for and transfer the oldest identical certificate from the inventory list to the friend since John Doe has not made his digital content available for sale. The friend may also sell their copy of the digital content (or access to the copy of the digital content) by selecting the “sell yours” button.

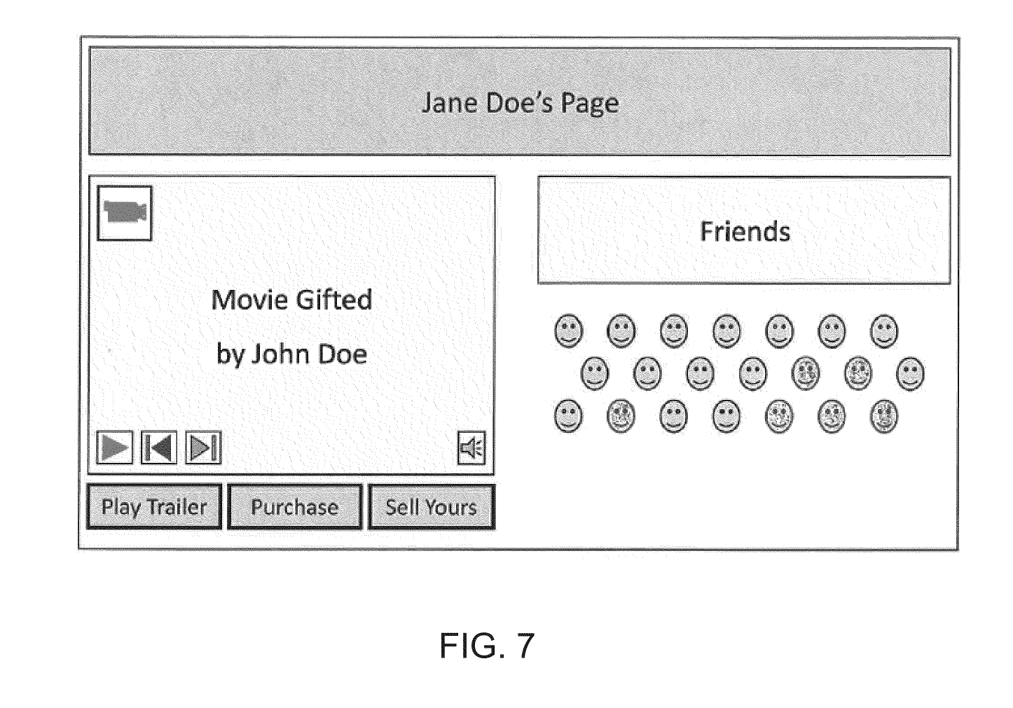

FIG. 7 is an example screenshot of a social network page of a user that has been gifted digital content. Once the user receives the gift from the “seller,” the user may watch the digital content directly on their own social network page. The social network connections of the user may also see the digital content the user was gifted. These network connections may choose to play the trailer of the digital content by selecting the trailer button, purchase the digital content for themselves by selecting the purchase button, or sell their own digital certificate for that digital content. This process also allows the user's network connections, who may not be connected to the seller, to have knowledge of what may be available for resale by the seller. The user may also transfer the digital certificate to the user's other devices and watch the content elsewhere. Each social network environment may allow users to view the digital media content in different manners whether directly on the social network platform or outside of the social media platform on the user's connected devices.

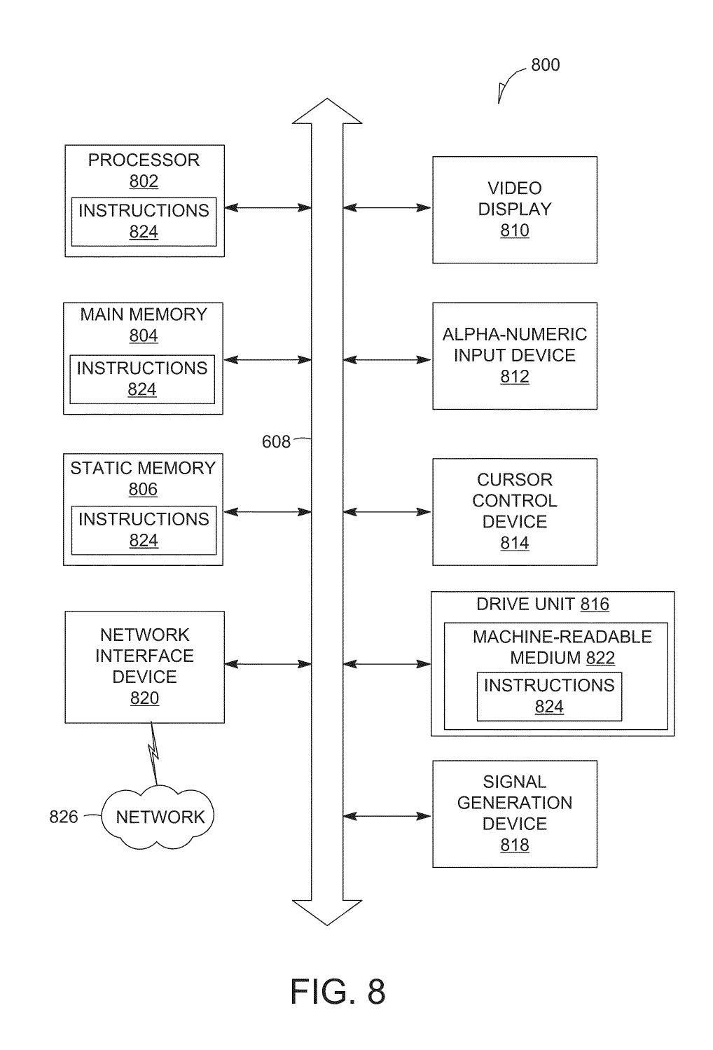

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alpha-numeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A social network enabled digital rights transfer method comprising:
receiving an indication to transfer digital rights in a digital content from a user of a social network;
determining a first network connection in the social network associated with the user;
causing presentation of an offer to transfer the digital rights in the digital content to the first network connection; and
transferring, using a processor of a machine, at least some of the digital rights in the digital content to the first network connection.

2. The method of claim 1, wherein the transferring of the digital rights comprises gifting the digital rights in the digital content to the first network connection.

3. The method of claim 1, wherein the determining comprises:
accessing profiles of the user and a plurality of network connections of the user; and
determining the first network connection based on similarity of predefined parameters of the profiles of the user and the first network connection.

4. The method of claim 1, wherein the determining comprises:
determining a characteristic of the digital content;
accessing profiles of a plurality of network connections of the user; and
determining the first network connection based on the profile of the first network connection indicating a preference for the characteristic of the digital content.

5. The method of claim 1, wherein the offer includes a link to an advertisement relating to the digital content.

6. The method of claim 5, further comprising receiving a selection from the user to use an official trailer as the advertisement.

7. The method of claim 5, further comprising receiving a selection from the user to create the advertisement using an excerpt of the digital content.

8. The method of claim 1, wherein the transferring of the digital rights occurs in response to receiving a purchase indication from the network connection via a social network page of the user.

9. The method of claim 1, further comprising:
receiving a request from a second network connection to purchase the digital content;
determining whether the user has further digital rights in the digital content to be transferred;
based on the user having the further digital rights, transferring the digital rights to the second network connection;
based on the user not having the further digital rights, determining whether other users in the social network are offering rights in the digital content; and
based on at least one other user in the social network offering rights in the digital content, transferring the rights to the second network connection.

10. The method of claim 9, further comprising, based on the determining that no other users in the social network are selling the digital content, providing a notification indicating a third party retailer selling the digital content.

11. The method of claim 9, wherein the transferring of the rights comprises transferring an oldest inventory of the digital content to the second network connection.

12. The method of claim 9, wherein the transferring of the rights comprises transferring the digital content that is closest in the social graph.

13. The method of claim 1, further comprising allowing a further network connection to sell a copy of the digital content owned by the further network connection by providing an indication via a social network page of the user.

14. A tangible machine-readable storage medium in communication with at least one processor, the machine-readable storage medium storing instructions which, when executed by the at least one processor of a machine, cause the machine to perform operations comprising:
receiving an indication to transfer digital rights in a digital content from a user of a social network;
determining a first network connection in the social network associated with the user;
providing notification of an offer to transfer the digital rights in the digital content to the first network connection, the notification including access to an advertisement for the digital content; and
transferring, using a processor of a machine, at least some of the digital rights in the digital content to the first network connection based on the first network connection accepting the offer.

15. A system comprising:
at least one processor of a machine; and
an inventory module to receive an indication to transfer digital rights in a digital content from a user of a social network;
a profile module to determine a first network connection in the social network associated with the user;
an advertisement module to cause presentation of an offer to transfer the digital rights in the digital content to the first network connection; and
a transaction module to transfer, using the processor of a machine, at least some of the digital rights in the digital content to the first network connection.

16. The system of claim 15, further comprising a content recognition module to monitor content viewed by a second user, and to provide recommendations of available digital content related to content viewed by the second user.

17. The system of claim 15, wherein the profile module determines the first network connection by:
accessing profiles of the user and a plurality of network connections of the user, and
determining the first network connection based on similarity of predefined parameters of the profiles of the user and the first network connection.

18. A mobile device storing instructions, which when executed by at least one processor of the mobile device, cause the mobile device to perform operations comprising:
causing presentation, at the mobile device, of an offer to transfer digital rights in digital content to a first network connection determined to be socially connected to a user in a social network that has indicated transferring digital rights in the digital content;
providing a purchase indication in response to the offer; and
receiving, using the at least one processor of a machine, an indication of a transfer of at least some of the digital rights in the digital content to the first network connection.

19. The mobile device of claim 18, wherein the offer includes a link to an advertisement relating to the digital content, activation of the link causing retrieve and display of the advertisement on the mobile device.

20. The mobile device of claim 18, wherein the purchase indication is provided via a social network page of the user displayed on the mobile device.
